(19) United States
(12) Patent Application Publication
(10) Pub. No.: US 2019/0262748 A1
(43) Pub. Date: Aug. 29, 2019

(54) SAFETY AND FLUID FLOW ENHANCEMENT DEVICE FOR FLUID TRANSFER SYSTEMS

(71) Applicants: Paul Crandall McKain, Tallahassee, FL (US); Fallon Leigh McKain, Tallahassee, FL (US)

(72) Inventors: Paul Crandall McKain, Tallahassee, FL (US); Fallon Leigh McKain, Tallahassee, FL (US)

(21) Appl. No.: 16/287,698

(22) Filed: Feb. 27, 2019

Related U.S. Application Data
(60) Provisional application No. 62/635,615, filed on Feb. 27, 2018.

(51) Int. Cl. B01D 35/02; F16L 55/24; B01D 29/31

(52) U.S. Cl. CPC B01D 35/02; E04H 4/1272; B01D 29/31; F16L 55/24

(57) ABSTRACT

A safety device for installation in a fluid transfer system includes an adapter having a front opening and a rear opening for directional flow of water therethrough, and a funnel-shaped flange surrounding the front opening for directing fluid flow through the adapter in a laminar flow with less turbulence. In one embodiment, the adapter is installed within a coupler sleeve for joining two pipe sections together to thereby improve fluid flow through the pipe in a fluid transfer system, while reducing vacuum pressure. In another embodiment, the adapter is fitted with a protective cap wherein the combined adapter and protective cap function as a standalone safety device to prevent entrapments and mitigate eviscerations. In still another embodiment, the adapter is fitted within a pump strainer basket to improve flow and reduce turbulence at the pump of the fluid transfer system.

This non-provisional patent application is based on provisional patent application Ser. No. 62/635,615 filed Feb. 27, 2018.

### BACKGROUND OF THE INVENTION

### Field of the Invention

The present invention relates to a safety device for fluid transfer systems, and more particularly, to a safety device that is structured to prevent an individual or object from obstructing the flow of water entering an opening of the fluid transfer system while also enhancing the flow of liquid or gas through the fluid transfer system.

### Discussion of the Related Art

Generally, one or two main drains are included on a swimming pool's floor or side wall as part of the swimming pool circulation system, which drains and filters pool water prior to directing the water back into the swimming pool. A drain sump at the swimming pool floor is in communication with the main drain and includes a drain grate for blocking access to the drain sump. The primary force in draining the pool water is the suction produced by the pool pump, which pulls water from the swimming pool into the main drain(s). The considerably high amount of suction produced by the pool pump has resulted in a number of accidents involving individuals swimming in the vicinity of the drain sump being trapped against the drain grate, creating a vacuum within the main drain between the obstruction and the pool pump, which can result in serious injury and/or death by drowning.

When drain covers become dislodged or compromised for any number of reasons, the drain orifice becomes exposed. The potential outcome of this incident is the encountering of the exposed drain orifice by a swimmer or bather.

When such an encounter occurs, the result is usually a tragic entrapment. These entrapment scenarios range from:
1. Full body—where a swimmer covers the entire opening of the sump or pipe orifice resulting in an immediate spike on vacuum trapping the swimmer to the sump or orifice.
2. Hair entanglement—where a swimmer's hair becomes entangled in the drain grate or orifice holding the swimmer underwater.
3. Limb entrapment—where the swimmer puts a hand or foot too close to the exposed orifice such that the vacuum of the pump on the system pulls the limb into the pipe trapping the swimmer underwater.
4. Mechanical entrapment—where a piece of jewelry, a string from a bathing suit or other article becomes tangled in the drain holding the swimmer underwater. Also in this category is the physiological effect that occurs with a limb entrapment. The resulting swelling of the entrapped extremity due to the intense suction force of the pump pulling body fluid into the limb causing the limb to swell further, making the entrapment even more extreme.
5. Evisceration—this is where the swimmer makes a total seal of the sump or orifice with their buttocks, the intense vacuum then causes the swimmers bowels to be pulled from their body and pulled through the piping system of the pool or whatever is connected to the pump.

The 5 types of entrapment mentioned above cannot be protected against by any single current device or technology on the market today, until now. The evisceration standard, the point at which an evisceration occurs, has yet to be determined and may never will as there are so many variables that come into play that even when a thresh hold is agreed upon, this point of measurement will still not be an absolute. It will just be a point that anti-entrapment technology will attempt to fall under. The only way to stop any type of entrapment—especially an evisceration—is to stop the development of the physical events leading up to the evisceration BEFORE they can develop. The present invention described below will do just this. It will stop the chain of events leading to all entrapment before they can begin, eliminating all 5 types of entrapments before they can even begin.

### Objects and Advantages of the Present Invention

Considering the foregoing, it is a primary object of the present invention to provide a safety and fluid flow enhancement device that can be easily installed to an existing fluid transfer system.

It is a further object of the present invention to provide a safety device that prevents limb and mechanical entrapment, hair entanglement and body entrapment in fluid transfer systems, and further mitigates the effects of evisceration, while also enhancing the flow of a liquid or gas through the fluid transfer system.

It is still a further object of the present invention to provide a retrofit device that eliminates limb, mechanical, hair entrapment and will mitigate the effects of an evisceration in pools, spas and wading pool when the drain cover becomes missing.

It is still a further object of the present invention to provide a prefabricated device that will eliminate all 5 types of entrapments in new construction or in major renovations of pools, spas and wading pools when the drain cover becomes missing.

It is still a further object of the present invention to provide a safety device above that will make it much more difficult to accidentally remove the drain cover and wherein the safety device will still act as a backup in the event of a drain cover removal.

It is still a further object of the present invention to provide a safety device that is more concise in size to accommodate systems like “prefabricated drains” currently being built into some pools, spas and wading pools when the drain cover becomes removed.

It is still a further object of the present invention to provide a safety device that is constructed from the adapter and attaches to the piping in the same manner and contains a removable cap that, if an entrapment begins to occur, will allow the cap to snap off releasing the swimmer while still leaving the adapter section in place to act as a back-up in case a swimmer should put an appendage into the adapter.

It is still a further object of the present invention to provide a safety device that improves flow and decreases vacuum draw by adding the adapter technology of U.S. Pat. No. 9,388,593 to couplers that can be used when piping any new system.

It is still a further object of the present invention to provide a device using the adapter technology mentioned above included in couplings that can be spliced into existing piping systems where ever the piping is available for insertion.

It is still a further object of the present invention to provide a specific device that utilizes the adapter technology in pump strainer baskets to allow for quick installation on any pump to increase the GPM while lowering vacuum levels, and which acts as a handle to remove the basket for periodic cleaning.

It is still a further object of the present invention to provide a device that by its intrinsic design can save energy by improving flow while also decreasing vacuum resulting in less run time, downsizing pump sizes, less stress on the running pump by increasing preload on the intake side and structuring flow through the piping making for more efficient flow.

It is still a further object of the present invention to provide a device that can be installed on various intakes, wherein the ability to draw from reservoirs of any size is enhanced and wherein the ability to pull material with a significant portion of the device out of the material (usually fluid of some sort) is maintained, where the prime would have been lost due to a partially exposed intake admitting atmosphere.

It is still a further object of the present invention to provide a device for use in agriculture, with the ability to function as stated above but not be hampered by blockages that may cover a predominance of the device, and the passive removal of debris by simply shutting off of the pump.

It is still a further object of the present invention to provide a device for use in aquiculture, with the ability to enhance flow of fluid (predominantly) while protecting the environment from being pulled into the intake piping and monumentally decreasing fish entrainment and impingement.

It is still a further object of the present invention to provide a device for use in desalination systems or water purifications, with the ability to perform the tasks mentioned above while actually increasing the intake of fluid, instead of decreasing fluid intake in an attempt to protect the environment as is currently accepted practice. By allowing increased intake, the result is increased output which is the desired outcome.

It is still a further object of the present invention to provide a device with all of the advantages set forth above and wherein the device can be used in all types of industries that are not limited to, but include the following: water decontamination and purification and desalination, waste water movement, in the energy fields including fracking, pot ash, coal, etc., industrial (land-field management, leachate, etc, solar powered or hybrid machines) or any machine that utilizes nutrient, element or chemical extraction from any kind of water.

### SUMMARY OF THE INVENTION

One embodiment of the present invention addresses a new way to use our prior patented invention directed to a safety device for use in a drain sump (e.g., in a swimming pool, spa or fountain) as disclosed in our U.S. Pat. No. 9,388,593, the contents of which are fully incorporated herein by reference. It is an expanded version of the original safety device for a drain sump. By slightly enlarging the surface area of the original safety device, it would allow the safety device to extend a little more above the rim of the sump. The value of this is that with the extension of the safety device vertically, the ability of the bather to make a complete seal over a sump without a drain cover is eliminated. This in turn eliminates the possibility of full body entrapment and evisceration. Hair, mechanical and limb entrapment are already eliminated by our original patent safety device which results in elimination of all 5 types of entrapments.

None of the 5 type of entrapments are going to occur if the drain cover is in place. The entrapments occur when the drain cover comes off and they always do. That is why on our new version of the safety device, we have chosen to use a new drain cover. We know that domed drain covers aid in removing the potential for making a full seal on drains, so we are incorporating this measure in our new design. The only difference being that since the safety device is extending vertically above the rim slightly more than our original safety device, we know we must increase the angle of the dome. We also know that in order to work with current cleaning devices on the market, we will have to extend the perimeter of the drain cover to allow for the cover to accommodate the extended height while at the same time accommodating the slope of the drain cover so as not to make too severe of an angle over the drain cover for pool cleaning devices. This expanded drain cover area also allows for more diffusion of vacuum from under the drain cover even further lessening the potential of entrapment on the cover. If the drain cover becomes missing, the extended safety device will still eliminate all 5 types of entrapments until the missing drain cover is noticed and replaced.

Even while the safety device is enclosed under the drain cover, it is still delivering the same energy savings and pump improvements that have been shown in testing derived from improved structural flow of the water passing through the safety device.

Our prior safety device, as set forth in U.S. Pat. No. 9,388,593, provides for diversion of vacuum to virtually eliminate these types of entrapment, but there are other types of construction that would not allow the technology to be utilized due to the size restriction. The more widely used type of construction that is too size restrictive for our previous patent safety device is the commonly used “field manufactured sump”. In short, this is where the builder of the pool literally builds the sump directly into the pool being constructed. For this reason, a new adaptation of the previously filed technology was needed. There are other instances where the smaller size of diverter is needed, but this is the one that will be directed to as it has been so commonly used in the past and is still in wide use in many new constructions.

In a previous invention, very simply is attached to the pool/spa/fountain piping by means of the adapter. The adapter slides into the piping and the safety device slides over the ridges of the adapter and secures with a stainless-steel screw. If necessary due to pool codes, the adapter can be glued into the pool piping.

The safety device of the present invention utilizes the same adapter technology as a previously patented safety device with modifications. The modification is to place a protective cap over a modified adapter. The adapter attaches to the piping in the same manner, by utilization of a single sticky sided Teflon type tape to hold it securely in the piping, then glued into place before or after attaching the safety cap. The domed angle of the cap will aid in elimination of various types of entrapments.

With so many pools being designed with field fabricated sumps, in essence sump less, the safety device of the present invention is the only method of protecting the bather from an entrapment in the event of a missing drain cover. Adaptation in the design of our original adapter now makes the safety device of the present invention not only safer in these pools but also in other areas of conventional pools. One instance that is paramount to use the new safety device is in skimmer by-pass lines. Currently there is no satisfactory protection for these orifices. In reality, in the first 2 weeks of the 2014 pool season in Brazil, these orifices were responsible for 4 entrapments.

Using the technology discovered in the adapter has led to using the same technology directly inside the piping system. In essence, the adapter, instead of being used as a stand-alone device outside of the system with the adaptations necessary to allow it to be used accordingly; it is known that the adapter in its original configuration can be built into pumps or piping systems to gain the value of the technology to more effectively move fluid and gas but not limited to these mediums.

The adapter coupling being in direct contact with the pump opening allows for a snug fit of the basket. The water entering the pump must flow through the adapter opening creating the laminar flow immediately but also increases preload on the intake of the pump by delivering more fluid at a higher velocity at start-up. This allows for a faster priming effect and more efficient clearing of air in the pump. The length of the adapter extending into the pump basket also acts as a handle to help in removing the basket for cleaning. The effects of the adapter built into the basket are 2-fold. 1—The vacuum is significantly reduced over the baseline of the pump running without the adapter in place and; 2—there is an increase in discharge of the pump in both velocity and gallons per minute. When used in conjunction with the adapter in the main drain (with or without our prior safety device attached in the drain sump) there is a pickup of flow and a further decrease in vacuum. The benefits are enhanced using the 2 adapters together over the benefits achieved using each one separately. Testing on placing an adapter in front of the pump intake repeatedly shows a quicker filling of the pump from a start-up and a cleaner smoother run. The most impressive response is placing the adapter directly into the pump basket.

### BRIEF DESCRIPTION OF THE DRAWINGS

For a fuller understanding of the nature of the present invention, reference should be made to the following detailed description taken in conjunction with the accompanying drawings in which:

FIG. 1 is a front side elevational view illustrating the safety device of our prior invention;

FIG. 2 is a perspective view illustrating the safety device of FIG. 1;

FIG. 3 is a rear perspective view of an adapter used in conjunction with the safety device of FIGS. 1-2;

FIG. 4 is a front perspective view of the adapter;

FIG. 5 is a side elevational view showing a coupler for joining two sections of pipe in a fluid transfer system;

FIG. 6 is an isolated view in partial cross-section, taken from the area indicated as FIG. 6 in FIG. 5 and showing the adapter of FIGS. 3-4 installed within the coupler between the two sections of pipe;

FIG. 7 is a top perspective view of the safety device of the present invention including the adapter and a cap having a plurality of openings and anti-hair entanglement mesh configuration, wherein the cap is shown removed from the adapter;

FIG. 8 is a top perspective view showing the safety device of the present invention with the cap fitted to the funnel end of the adapter in a fully assembled state; and

FIG. 9 is a perspective view showing the adapter fitted within a pump basket for connection with the intake line of the pump basket in a fluid transfer system, such as a swimming pool pump system.

Like reference numerals refer to like parts throughout the several views of the drawings.

### DETAILED DESCRIPTION OF THE PREFERRED EMBODIMENTS

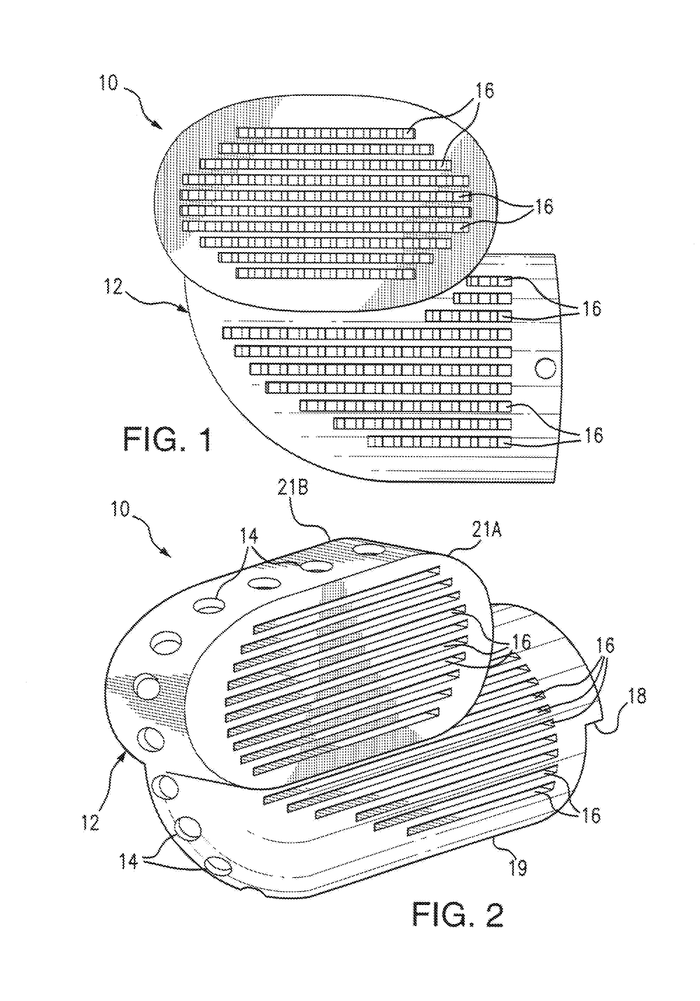

Referring initially to FIGS. 1-2, the safety device 10 of our prior invention (U.S. Pat. No. 9,388,593) is shown. The prior safety device 10 includes a “T” shaped drain adjunct member 12 having vacuum relief holes 14, anti-hair entangling mesh 16, and a semi-annular receiving rim 18 partially surrounding an attachment opening 20. As shown in FIG. 2, the drain adjunct member 12 includes opposing orifices 21A and 21B extending outwards from a main body 19. Preferably each orifice 21A and 21B is at least partially covered in anti-hair entangling mesh 16. The “T” shaped drain adjunct member 12 is predominantly hollow, forming a water flow passage 23 between the attachment opening 20 and the multiple water inlets (vacuum relief holes 14 and anti-hair entangling mesh 16) to produce a directional flow of water therethrough into a main drain pipe 24.

Referring specifically to FIG. 2, the vacuum relief holes 14 extend along the top side and back side of the drain adjunct member 12. The arrangement of the vacuum relief holes 14 prevents a vortex from forming by pulling water from several different locations through the drain adjunct member 12 and into the drain adjunct member 12, thereby disrupting the flow pattern of the water being pulled into the main drain pipe. While the vacuum relief holes 14 are shown to be arranged in single file order along the center line of the top side and back side of the drain adjunct member 12, the relief holes 14 may be arranged in any manner suitable for preventing the vortex effect upon entering the water flow passage of the drain adjunct member 12. In a preferred embodiment, the vacuum relief holes 14 are sized to allow entry of debris that enters the drain sump, thereby allowing the debris to passively pass through the main drain pipe and filtration system for removal by the pool or spa filter.

The anti-hair entangling mesh 16 is provided to prevent entrapment by hair entanglement and further serves as an additional inlet for water to enter the water flow passage of the drain adjunct member 12 for further disrupting the water flow pattern. As shown in the Figures, the anti-hair entangling mesh 16 is included on orifices 21A and 21B as well as the front and back sides of the main body 19 of the drain adjunct member 12.

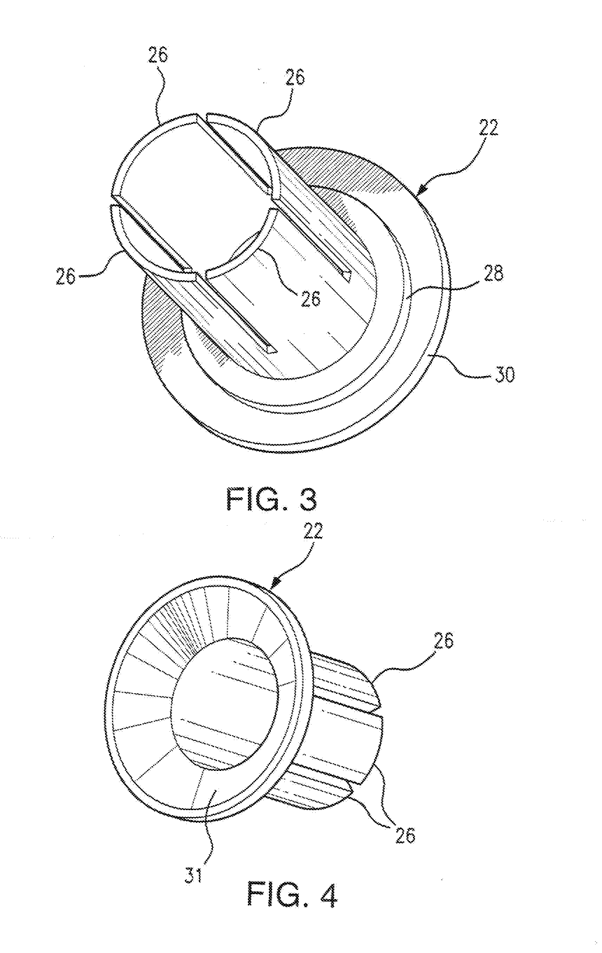

Referring to FIG. 3, an attachment adapter 22 is provided for securing the drain adjunct member 12 to the main drain pipe 24, which is in connection with the pool or spa pump. The attachment adapter 22 includes prongs 26 extending from the main body of the adapter 22 sized for fitted insertion within a main drain pipe. When the prongs 26 are fully inserted within the main drain pipe, a first annular rim 28 that is sized larger than the opening of the main drain pipe comes into abutment against the opening of the main drain pipe, leaving a second annular rim 30, which is sized larger than the first annular rim 28, exposed. The second annular rim 30 is provided for attachment to the drain adjunct member 12, wherein the semi-annular receiving rim 18 on the drain adjunct member 12 is sized to receive the second annular rim 30 for secured attachment thereto. The design of the adapter 22 reduces fluid turbulence and creates a laminar flow which results in a parabolic effect within the piping. In particular, as shown in the embodiment of FIG. 4, the funnel-shaped entry 31 of the adapter 22 leading to the adapter interior serves to direct the water in a laminar flow with less turbulence. This effect, in turn, streamlines the flow of water into the main drain pipe, resulting in less power required to run the pool or spa filtration system. The design of the adapter 22 that structures the laminar flow can be applied to skimmers as well as various locations within the piping system to continue the structured flow. This in turn will decrease the work load on the pump and increase water flow thereby saving energy by decreasing the pump's work load and limiting the time that the pump needs to run to accomplish the necessary water turnover.

A problem that exists in pools today is that a bather can put their limbs into the skimmer vacuum orifice and have said limb pulled into the piping creating an entrapment. Although the bather is above water level, the pool piping frequently needs to be removed from the pool decking in order to extricate the limb. Installing an adapter 22 in a skimmer not only improves the flow rate and increases the debris removal by increasing the flow rate, but it also acts as a safety device. Should a bather have their limb pulled into the adapter 22 located in the skimmer return orifice, the bather may simply pull back from the vacuum force, thereby pulling the adapter 22 and the limb from the skimmer return orifice and eliminating the entrapment.

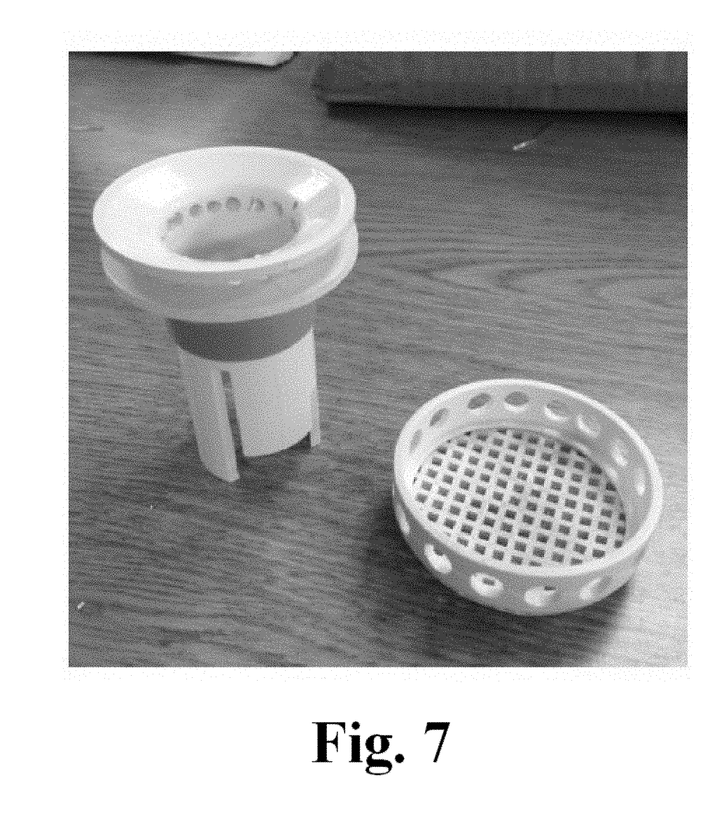

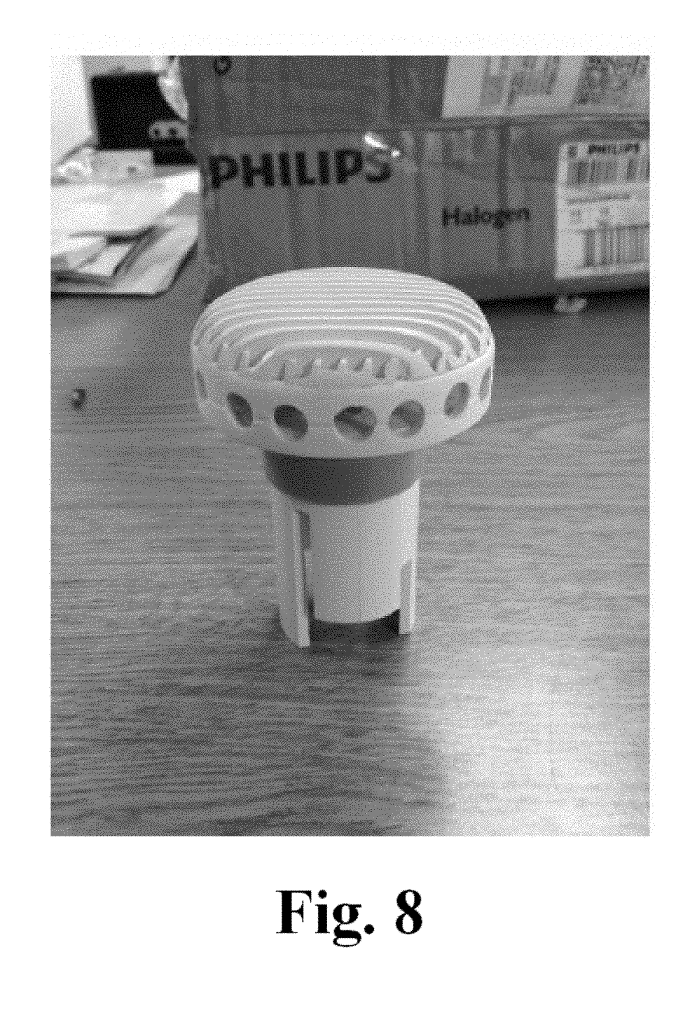

The safety device of the present invention utilizes the same adapter technology as a previously patented safety device with modifications. Referring to FIGS. 7-8, the modification is to place a protective cap over a modified adapter. The adapter attaches to the piping in the same manor, by utilization of a single sticky sided Teflon type tape to hold it securely in the piping, then glued into place before or after attaching the safety cap. The domed angle of the cap will aid in elimination of various types of entrapments.

A series of holes are placed between the ¼″ slot of the ridge. This allows for deviation of vacuum in the event of a blockage in the surface of the adapter. Using this means of deviation in vacuum, the vacuum cannot be created on the adapter to even require the need to pull it free although it still can be if desired. The cap as shown in the picture wraps around the holes in the ridge with larger holes of its own allowing water passage (vacuum). As stated earlier, these holes in the cap can be also constructed of anti-hair entangling mesh or a combination of mesh and holes if desired depending on desired flow. Of importance, all venting holes must conform to the current pool code which is currently no larger diameter than ⅜″. If the code changes the maximum diameter size, the product relief holes will conform to the current changes.

Although not required to pass a 15-pound buoyancy blockage test, due to the fact that we are a diverter and no tests are required of diverters, the adapter when configured with multiple relief holes can allow the blocking element to release from the adapter unless in an over powered system. In this event, the adapter will still deviate vacuum away from the blocking element, in actual usage situations that would be a bather, and require minimal effort to break the vacuum on the adapter while the relief holes are still diverting the force away from the bather/blocking element. If desired, the adapter can be pulled from the piping but it would not be necessary as the holding force of the pump is minimal on the adapter.

The safety device of FIGS. 7-8, with the relief holes actually deviates vacuum proportional to the amount of vacuum being created by the system. If the system is flowing at the appropriately designed flow rate, there would be no need to remove the adapter in the event of a bather coming into contact with it as the diversion of vacuum would not require such an action. In the event of a system that has been changed or over powered, the relief holes will still divert the majority of the vacuum force but may have too much residual force to allow a sufficient amount of vacuum to be diverted through the relief holes. In this event, the adapter may still have to be pulled from the piping as originally designed, yet a minimal amount of physical force will allow the bather to break the vacuum on the adapter while the relief holes are functioning. This type of safety device works best when the system has not been over pumped by increasing the size of the pump on the system.

Interestingly enough, in field fabricated sumps, the safety device of the present invention can protect against full body entrapment along with hair, mechanical and limb entrapments. We cannot claim evisceration in this embodiment as that threshold has not been fully established. Under worst case scenarios the safety device could allow the human buttocks to cover a majority of its surface area so an evisceration could be possible except that there would be nowhere for intestinal material to go so the resulting damage would more than likely be an avulsion.

The cap of the safety device is constructed with a hair entrapment mesh located over the main fluid orifice. The relief holes would most usually be present in the area distal to the laminar structuring flange for deviation of vacuum should an entrapment begin to occur. The mesh could take on many configurations depending on the available area it would have to fit within under the drain cover. The cover could also be configured with ⅜″ holes in place of the mesh for additional flow or could be used in combination with the mesh as in our prior safety device shown in FIGS. 1-2. The ⅜″ holes are only that diameter since that is the largest diameter allowed by code in the pool/spa industry. The hole size could be of any desired size if used in any industry other than the pool/spa industry.

Convex designs would make it more difficult to cover in the event of a drain cover becoming compromised or missing and would actually eliminate all the mechanisms of entrapment including evisceration as a blockage could not occur nor would the pipe be exposed to allowing bodily material to access it.

The assembled safety device (FIG. 8) is constructed to allow the top section (cap) to be pulled free in an emergency situation while still maintaining the bottom section of the adapter in the piping providing an additional layer of protection until the cap can be replaced. If necessary, to comply with safety standards or codes, the cap can be attached with stainless steel screw(s). This would be unfortunate and would be appealed to by us to compliance committees to allow for a double backup safety system instead of just one.

The same design can be made utilizing a series of holes where the mesh is located. The biggest advantage in using this method is the acquisition of even more open area for water to flow through. Both of the versions eliminate hair entanglement, but the version with the open holes can function at a higher level than should be moved through a 1½″ or a 2″ pool/spa system. Any sized safety device of the present invention can be made to fit any size pipe as it is not restricted to any given size pipe. It is merely a direct correlation of pipe size to the safety device size.

The aspects of increasing fluid/gas transfer are one of the “unanticipated consequences” which we will go into great detail. The discovery protects and advances performance with the same introduction of the technology into the same application which makes this technology invaluable to both life safety but also to better usage of fluid in motion and energy consumption because by moving fluid more efficiently, less energy is consumed.

Using water as the medium discussed, although we know that the technology is not restricted to water or even fluid, it has been shown that the adapter technology, depending on the area of placement within the system can:
1. Decrease energy usage by allowing less running time of the pump to accommodate the same desired water turn-over rate. (PA) and/or (AA)
2. Decrease work load on a pump by increasing preload requiring the pump to work less hard, possibly also decreasing energy requirements but definitely increasing the speed and overall ability of a pump to gain its prime. (PA) and/or (AA)
3. Increasing flow through the system, in front of or after pumps, appliances, turns or whatever obstruction that disrupts flow. In many placements a decrease in running vacuum is acquired while maintaining the same or increased flow. (PA) and/or (AA)
4. Reduce or eliminate turbulence at and/or after 90 degree turns that obstruct water flow at the molecular level and can even contribute to less breakdown of materials being carried within the water medium by decreasing the effect of the turbulence following 90 degree turns and also the length of time the turbulence affects the water and materials being transported within it, example being chlorine or other chemicals used to clean and sanitize the water. (PA) and/or (AA)
5. Increase the speed of travel through the piping system by creating a laminar flow pattern that makes for a smoother, freer flowing fluid. When longer runs are present, a parabolic pattern can develop increasing flow even further. (PA) and/or (AA)
6. Use of a collector to enhance the pick-up of fluid into the adapter, which in turn enhances the benefits seen from an adapter without the collector. (AA)

The relief holes in the adapter of the present invention (see FIGS. 7-8) allow some water to flow through them because of the vacuum of the pump. The majority of the flow takes the path of least resistance which is through the adapter's main orifice (front) opening. This is the opening where the laminar flow pattern is developed. As the flow through the adapter's main orifice passes the relief holes, due to its higher velocity a venturi effect develops and increases the flow through the relief holes which in turn increases the pull of the surrounding water towards the main orifice opening enhancing the laminar effect. The greater the angle away from the 90 degrees the more participation is seen via the venture effect. At 90 degrees, there develops a slight turbulent resistance as the water through the relief holes collides with the laminar developed flow through the main orifice. As the angle drops off from the 90 degree a smoother flow can be seen due to the elimination of the conflicted water flowing through the relief holes. Instead of being forced through the 90-degree holes, the water is enhanced by joining the flow of the laminar structured pattern of the water.

The adapter as originally designed and tested by the University of Denver showed a decrease in Turbulent Kinetic Energy in the sump in which it was connected and also showed the formation of a laminar flow pattern in the water passing through it. This function was covered in a previous provisional patent application. Since that filing we have become aware of a system of pool construction that does not use a drain sump in the bottom or sidewall of pools. In fact, pipes are brought directly into position in the pool and a drain cover is attached directly over the pipe (field fabricated sumps).

Using the technology discovered in the adapter has led to using the same technology directly inside the piping system. In essence, the adapter, instead of being used as a stand-alone device outside of the system with the adaptations necessary to allow it to be used accordingly; it is known that the adapter in its original configuration can be built into pumps or piping systems to gain the value of the technology to more effectively move fluid and gas but not limited to these mediums.

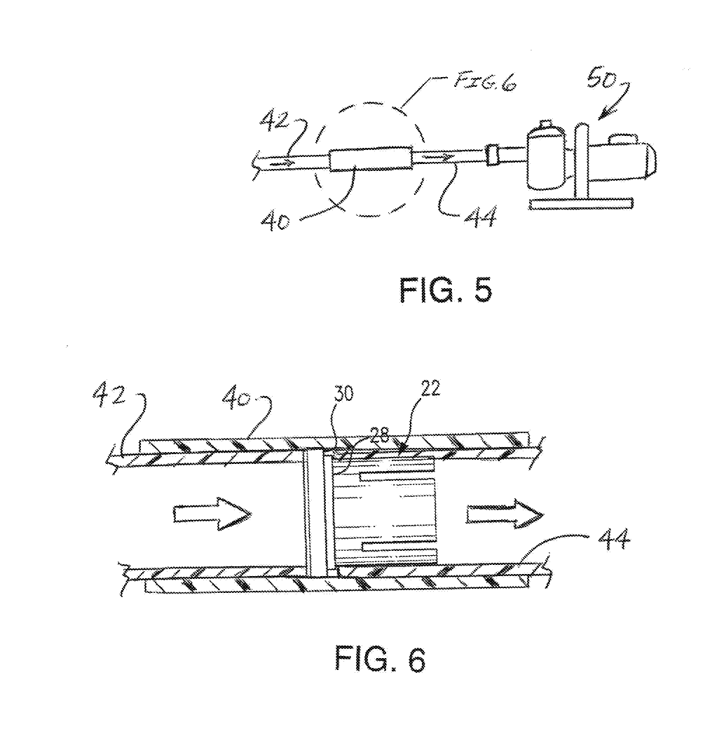

When pipe is connected together, a coupler is used. An example of a coupler 40 used to join two pipe extensions 42, 44 together is shown in FIG. 5. Couplers come in various lengths. Couplers are designed in such a way as to be slightly larger than the outside diameter of the pipe to be joined (glued). When the glue is brushed around the end of the pipe (42, 44) and the internal diameter of the coupler, the pipe (42, 44) slides into the coupler 40 and rests on a built-in stop. The stop is in the center of the coupler 40 and is a VERY small raised area so the pipe only goes this far into the coupler.

The adapter 22 of the present invention is designed to slide into the coupler 40—without glue. It would only be ½″ long so it would not take up too much of the glued area of the coupler and so not compromise the integrity of the pipe that will now glue into the remaining section of the coupler. Referring to FIG. 6, the adapter 22 is shown securely held into place within the coupler 40 by the glued pipe sections 42, 44. This does not eliminate the possibility of gluing the insert in the piping but just offers a simpler method of secure attachment.

All the benefits of an adapter can now be delivered as often as desired when connecting piping by using the adapter 22 in existing couplers or premade adapter couplers that already contain the adapter 22 as mentioned above.

Of importance, although the principle of the adapter insert is to make for a smooth transition of water from the pipe and entering the adapter insert 22 and then leave the adapter insert with little or no turbulence created in the continuing pipe, there is an unusual occurrence known where the turbulence can be of benefit. The overall design is to limit the turbulent kinetic energy and create a laminar flow, but the knowledge of how to create a desired amount of turbulence is known and can be duplicated if desired. Also, the angle of design of the adapter insert 22 can change the flow rate (laminar flow) of material (fluid, gas, etc. . . . ) and the amount of turbulent kinetic energy that results from the degree of angle. By increasing or decreasing the angle, the desired results can be altered with the understanding that various materials being transported will react differently to different angles.

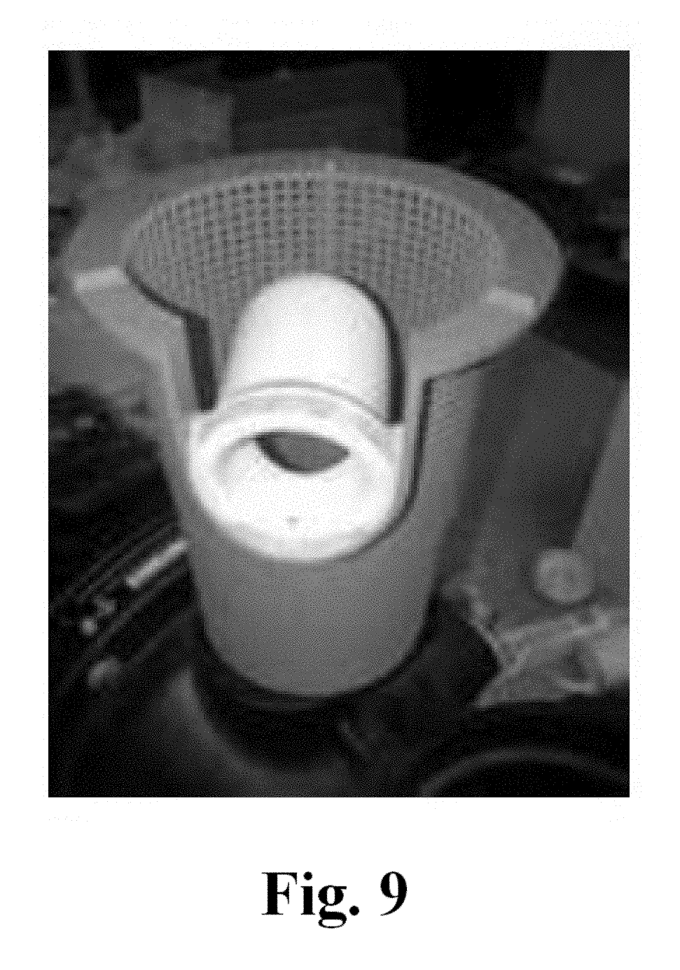

Further, the inclusion of the adapter technology can be incorporated into the design and manufacture of all current and future pump strainer baskets (see FIG. 9) that, when the basket/adapter product is inserted into the pump basket receptacle, will line up with the piping in the pump intake side of the pump, improving flow to the pump relieving back pressure and enhancing priming operations of the pump.

While the present invention has been shown and described in accordance with several preferred and practical embodiments, it is recognized that departures from the instant disclosure are fully contemplated within the spirit and scope of the present invention which is not to be limited except as defined in the following claims as interpreted under the Doctrine of Equivalents.

What is claimed is:

1. A safety device for use in a fluid transfer system, comprising:
an adapter having a front opening and a rear opening for directional flow of water therethrough, the front opening being surrounded by a funnel-shaped flange, the funnel-shaped flange being shaped, structured and configured for directing flow of fluid in a laminar flow through the adapter for exit at the rear opening; and
the adapter being structured and disposed for inline installation within a fluid transfer pipe of the fluid transfer system.

2. The safety device as recited in claim 1 wherein the adapter is structured and disposed for installation within a coupler sleeve joining two pipe sections together, with the funnel-shaped flange of the adapter positioned between opposing ends of the pipe sections.

3. The safety device as recited in claim 1 further comprising:
a cap structured and disposed for releasable attachment over the funnel-shaped flange of the adapter to cover the front opening of the adapter, and the cap including a plurality of openings therethrough for allowing fluid to flow through the cap and through the adapter.

4. The safety device as recited in claim 3 wherein the cap includes an anti-hair entanglement mesh structure cooperating with the plurality of openings therethrough.

5. The safety device as recited in claim 1 wherein the adapter is structured and disposed for placement within a pump strainer basket in the fluid transfer system.
